(19) United States
(12) Patent Application Publication
(10) Pub. No.: US 2016/0239531 A1
(43) Pub. Date: Aug. 18, 2016

(54) INTEGRATED FRAMEWORK FOR DATA MANAGEMENT AND PROVISIONING

(71) Applicant: MEENAKSHI SUNDARAM P, Walldorf (DE)

(72) Inventor: MEENAKSHI SUNDARAM P, Walldorf (DE)

(21) Appl. No.: 14/621,382

(22) Filed: Feb. 13, 2015

(51) Int. Cl. G06F 17/30

(52) U.S. Cl. CPC G06F 17/30371; G06F 17/30569; G06F 17/30575

(57) ABSTRACT

Methods and system are disclosed that assist improving user experience, when consuming business data. In one aspect, a framework middleware receives a request via an application to establish connection with a multiple systems. Upon establishing the connection, the business data from the multiple systems may be retrieved. The retrieved business data may be transformed by triggering system landscape transformation data model. From the transformed business data, contextual information associated with the business data may be determined. The determined contextual information may be displayed on a user interface or a dashboard that is instantiated by the application. The contextual information displayed on the user interface is customized based on user preferences that enhances and improves user experience when consuming business data.

### BACKGROUND

Enterprise data, when accessed by different systems in an enterprise, may result in scattering of original information. The systems accessing the enterprise data may be deployed on different platforms that may lead to fragmenting the infrastructure via which the enterprise data is accessed and provisioned. When such scattered information is accessed and consumed via fragmented infrastructure, there may be latency and inconsistency introduced into the process of consuming the enterprise data. Fragmented infrastructure may also add overheads such as need for a complex infrastructure resulting in undesirable user experiences, limited personalization of content, inefficient user management and access control rights, inefficient content management techniques, etc. Therefore, providing an infrastructure that facilitates efficient user and information management that enhances and improves the overall experience of the user when consuming the enterprise data may be challenging.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating environment to display contextual information associated with business data, according to an embodiment.

FIG. 2 is a flow diagram illustrating a process to display contextual information associated with business data, according to an embodiment.

FIG. 3 is a block diagram illustrating a system that provides a platform for displaying contextual information associated with business data, according to an embodiment.

FIG. 4 is a block diagram illustrating a sequential data encrypting algorithm to encrypt business data, according to an embodiment.

FIG. 5 is a block diagram illustrating an integration of user management framework and framework middleware, according to an embodiment.

FIG. 6 is a block diagram illustrating a user management service class, according to an embodiment.

FIG. 7 is a block diagram showing a dashboard displaying contextual information associated with business data, according to an embodiment.

FIG. 8 is a block diagram illustrating a user interface displaying contextual information associated with business data, according to an embodiment.

FIG. 9 is a block diagram illustrating a dashboard displaying contextual information associated with business data, according to an embodiment.

FIG. 10 is a block diagram illustrating a dashboard displaying contextual information associated with business data, according to an embodiment.

FIG. 11 is a block diagram illustrating a user interface displaying contextual information associated with business data, according to an embodiment.

FIG. 12 is a block diagram illustrating a user interface displaying contextual information associated with business data, according to an embodiment.

FIG. 13 is a block diagram illustrating a user interface displaying contextual information associated with business data, according to an embodiment.

FIG. 14 is a block diagram of a computer system, according to an embodiment.

### DETAILED DESCRIPTION

Embodiments of techniques related to integrated framework for data management and provisioning are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Rapid technological evolution has contributed to growth of enterprises. Such a growth has resulted in an increased volume of business data associated with an enterprise. Such business data may be stored in data repositories (e.g., data stores, databases, etc.) that may be geographically distributed. The business data may be accessed and modified by multiple systems and applications across different platforms in the enterprise. In such a scenario, the integrity and consistency of the business data may be affected. The enterprise may provide access to the business data through a framework (e.g., a framework middleware). The framework middleware may facilitate provisioning the business data by maintaining consistency, security and integrity of the business data. The framework middleware may provide unification of architecture and design across different platforms to enable reusability of system and application components (e.g., existing user interface (UI) applications or parts of applications, business data, etc.). The framework middleware applications may optimize the performance of the systems and applications that may work in conjunction with each other.

In an embodiment, the framework may support storing business data in systems and applications that may be deployed on premise or in distributed environment (e.g., cloud computing environment). The framework middleware may provide a platform that may work in conjunction with an application (e.g., data provisioning application) and multiple systems (e.g., business management systems, such as Partner Relationship management (PRM), Enterprise Resource Planning (ERP), Customer Relationship Management (CRM), Service Mobile Platform (SMP), Ramp-up Knowledge Transfer (RKT), Learning Solutions (LSO), etc.). A business management system may include an integration of applications for facilitating and managing business activities in an organization. The framework middleware may be in communication with the application and the multiple systems. The application may provision business data that may be personalized and customized based on a preference of an end user. The application may be designed based on a model view controller (MVC) which may provide definitions to distinguish between operations, such as processing control, data models and displaying the business data on a user interface or a dashboard.

In an embodiment, the application designed based on MVC may be used as an object that may be used to administer the business data. Such an object may respond to information requests from the process control. The object may process the business data independently, without referencing the application. In an embodiment, personalizing the business data may include determining: contextual information associated with the business data, user preferences, application of localization rules, application of language preferences, etc. Further the provisioning of personalized business data may be enhanced by customizing the personalized business data using business rules and user interface (UT) components. Such customization may enhance and improve the user experience, when consuming the business data.

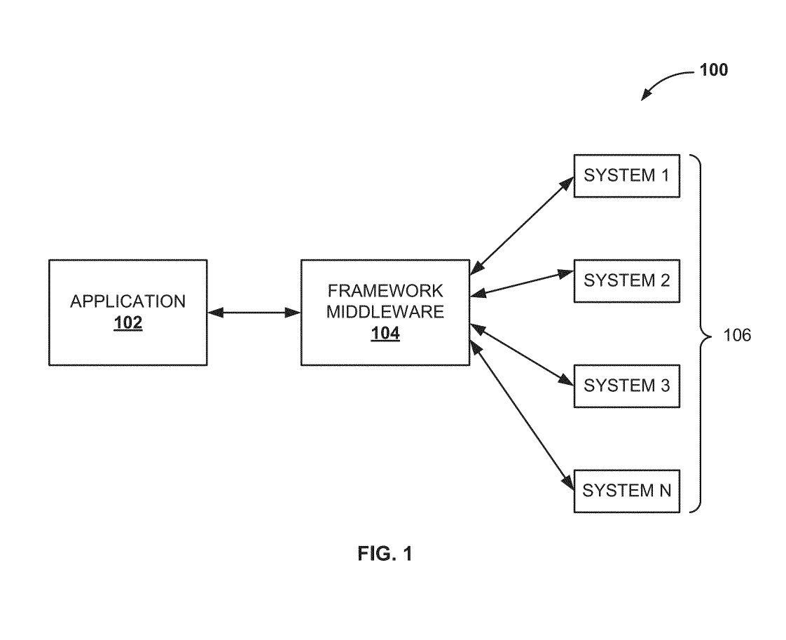

FIG. 1 is a block diagram illustrating environment 100 to display contextual information associated with business data, according to an embodiment. By way of illustration, FIG. 1 shows application 102 (e.g., data provisioning application) in communication with framework middleware 104. The framework middleware 104 may be in communication with multiple systems 106 (e.g., business management systems). In an embodiment, application 102 may include an integration of multiple user interface (UI) components, UI engines, business rules, theming rules (e.g., themes for customizing the business data), user session management rules, etc. The UI components and engines may facilitate customizing personalized business data and displaying the customized business data on a user interface (not shown) or a dashboard (not shown) to enhance and improve user experience when consuming the business data.

In an embodiment, framework middleware 104 may include an integration of multiple routines (e.g., sequence of program instructions), operational engines (e.g., data customization and content management engines, user management engine, etc.), data models, etc. The multiple routines may be executed by the processor to execute specific functions or tasks. The framework middleware 104 may execute tasks such as triggering data models, retrieving business data from the multiple systems (e.g., 106) using data services, retrieving the business data from the multiple systems (e.g., 106), replicating the business data to the multiple systems (e.g., 106), transforming business data based on system landscape transformation models, structuring business data based on the data models, managing users (e.g., registration, creating user identity, authorization, authentication, etc.) across the multiple systems, maintaining consistency and integrity of the business data, encrypting the business data, triggering events within or between the multiple systems, etc.

In an embodiment, framework middleware 104 may receive a request from application 102 (e.g., data provisioning application) to establish a connection with the multiple systems 106. A user logged into application 102 may be authenticated by executing routines in framework middleware 104. The framework middleware 104 may retrieve the business data from multiple systems 106 an transform the retrieved business data by triggering system landscape transformation model. Based on user credentials (e.g., user roles, attributes related to information access, etc.), framework middleware 104 may determine contextual information associated with the transformed business data. Upon determining the contextual information, application 102 may instantiate a user interface or a dashboard to display the contextual information associated with the transformed business data. The contextual information displayed on the user interface or dashboard may further be customized based on user preferences to enhance and improve the user experience, when consuming the business data.

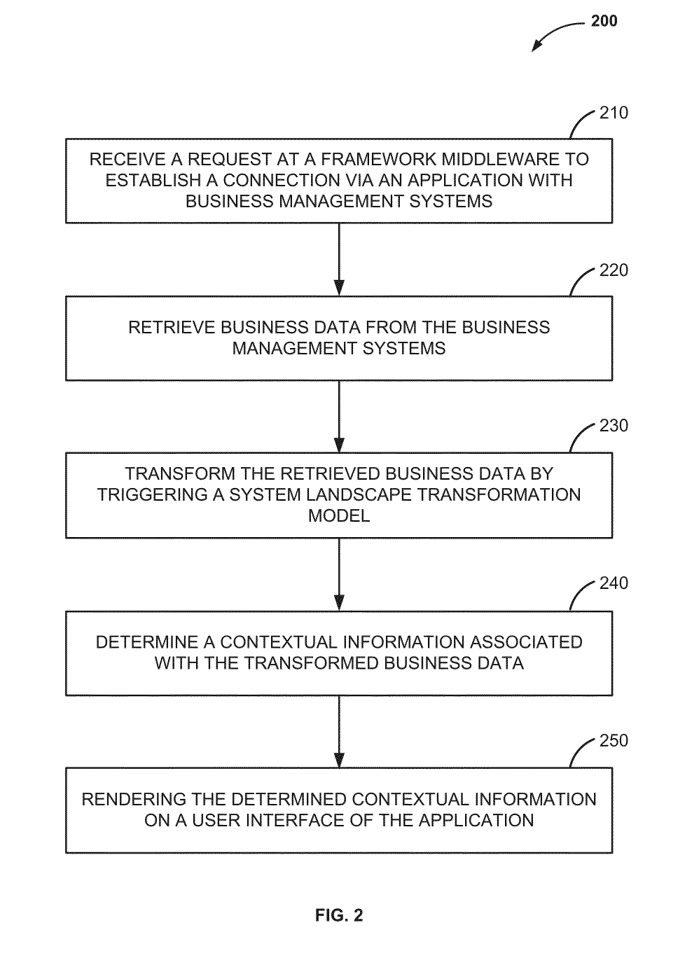

FIG. 2 is a flow diagram illustrating a process 200 to display contextual information associated with business data, according to an embodiment. Process 200, upon execution, determines contextual information associated with business data and displays the determined contextual information on a user interface or a dashboard. The contextual information displayed on the user interface or the dashboard may be personalized and customized (e.g., by theming, styling content) based on user preferences, in an embodiment, a framework middleware may be in communication with an application and multiple business management systems (e.g.,106). The application may provide a platform (e.g., data provisioning platform) for consuming the business data by a user. Such platform may include an integration of user interfaces or dashboards that may be instantiated by the UI engines to render the business data. The application may work in conjunction with the framework middleware. The application may execute functionalities such as access control to multiple related, but independent software systems (e.g., single sign-on implementation (SSO)), session management, filtering of business data based on location (e.g., localization), enhancing graphical appearance of the business data using graphical control elements, window size and shapes, etc.

In an embodiment, the framework middleware receives a request to establish a connection via the application with the multiple business management systems, at 210. The application may be executed in memory by a processor on a general purpose computer. The application may be deployed in an on premise computing environment or distributed computing environment (e.g., cloud computing environment). In another embodiment, the application may be customized and deployed to execute as a mobile application on a tablet computer, a mobile device, a multifunction portable electronic device, etc.

In an embodiment, upon establishing the connection, the framework middleware retrieves the business data from the multiple business management systems, at 220. The business data retrieved from the multiple business management systems is transformed by triggering the system landscape transformation model, at 230. The retrieved business data may be transformed by the execution of system landscape transformation model. Such a transformation modifies the business data to conform to the data models. For instance, business data in one format (e.g., a word processing complaint format, such as .doc, .docx) may be transformed to another format (e.g., based on data models that may correspond to plain text format; rich text format, etc.). In another instance, transforming the business data may include integrating business process model and business data (e.g., using business rules; identifying entity types (binding of business data and functionality); etc.). The data models may include definitions and format of business data and may provide a unified platform for development of information systems.

In an embodiment, the transformed business data may be structured, be associated with contextual information and may include identifiers. The identifiers may provide functionalities, such as determining the contextual information, providing access control to business data and/or the contextual information, business data localization, filtering and customization based on user preferences, etc. In an embodiment, the contextual information may be rendered on the user interface or the dashboards upon authenticating the user. The identifiers associated with the contextual information may be matched with the user attributes (e.g., attributes related to user authorization or authentication, user preferences, etc.) to determine and provide access to the business data.

In an embodiment, the contextual information associated with the business data is determined, at 240. The contextual information associated with the business data may be determined by executing the routines in the framework middleware. The execution of the routines may include matching the user attributes and the identifiers associated with the contextual information associated with the business data. In an embodiment, the user attributes may be related to a designation (e.g., role and responsibilities of a user/employee in an organization), regional and language preferences, preferences related to contextual information associated with the business data, user identity, accessibility and authorization, etc.

In an embodiment, the application may instantiate the user interface to display the contextual information determined at 240. The contextual information is rendered (e.g., displayed) on the user interface, at 250. The contextual information displayed on the user interface is personalized or customized based on user preferences and authorization privileges. In an embodiment, the customizing engines in the application may customize the contextual information to enhance and improve visual appearance of the contextual information displayed on the user interface.

In an embodiment, the framework middleware may communicate with multiple business management systems (e.g., business management systems, such as CRM, ERP, PRM, SMP, RKT, LSO, etc.). As explained previously, the business data from the multiple business management systems may be transformed by the execution of system landscape transformation model in the framework middleware. The business data from the multiple business management systems may be stored in multiple geographically distributed databases. In an embodiment, the framework middleware may include routines related to content management engines, such as web content management engine, document management engine, dashboard management engine, widget management engine, workflow management engine, etc., that may work in conjunction with each other. The content management engines may be triggered by workflow management routines to execute respective functions.

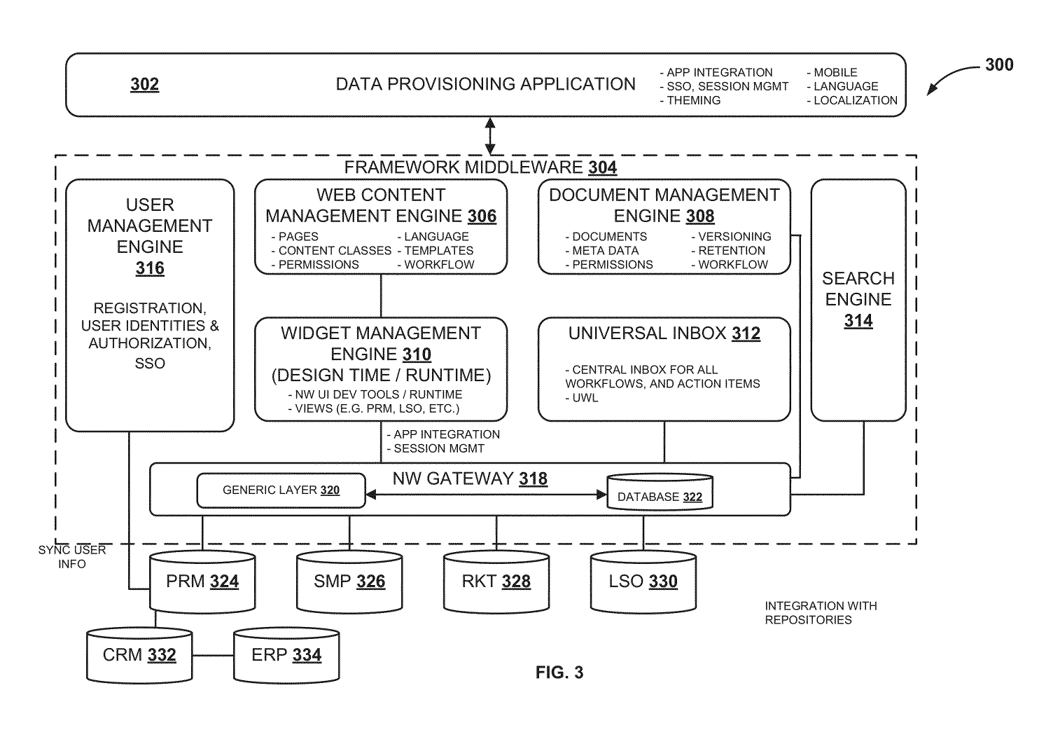

FIG. 3 is a block diagram illustrating a system 300 that provides a platform for displaying contextual information associated with business data, according to an embodiment. By way of illustration, FIG. 3 shows data provisioning application 302 (e.g., a platform that improves user experience) in communication with framework middleware 304 and multiple business management systems 324, 326, 328, 330, 332 and 334 over a network (not shown). In an embodiment, data provisioning application 302 may include an integration of multiple application user interface (UI) components and different fields, and may be capable of storing business data from multiple business management systems 324, 326, 328, 330, 332 and 334. The UI application components may be created using a generic data model (e.g., business data including metadata). The data model is generic and includes data fields that may accommodate business data from the multiple business management systems as per user preferences.

In an embodiment, framework middleware 304 includes an integration of routines related to: triggering system landscape transformation data models, providing/consuming data services, managing users via user management engine 316, managing content using content management engines, such as web content management engine 306, document management engine 308, widget management engine 310, workflow management engine (not shown), universal inbox 312, search engine 314, network (NW) gateway 318, etc. The above data models and engines (e.g., 306, 308, 310, 312, 314, and 316) may work in conjunction with each other. In an embodiment, the system landscape transformation model may trigger operations (e.g., execute operations such as delete, update, modify, add, etc., on database tables). The system landscape transformation model may include mapping information associated with the business data (e.g., storage information related to the business data.

In an embodiment, web content management engine 306 may include content classes, access control parameters, provisioning for customization and content management including language preference, templates, workflow, web pages, etc. The document management engine 308 may provision for customization and management related to digital documents including access control parameters, meta data, versioning, workflow, retention, etc. In an embodiment, widget management engine 310 may be configured during the design time. The widget management engine 310 may provide customized widgets that may be added to dashboards or user interfaces to enhance and improve the visual appearance of the information displayed. The widget management engine 310 may be configured using network tools during design time and executed during runtime. Additionally the widget management engine may be used to generate views that may be associated with the multiple business management systems 324, 326, 328, 330, 332 and 334. The universal inbox 312 serves as a central inbox for all workflows and action items. The search engine 314 may execute search queries and may enable searching for the business data. The network gateway 318 may communicate with universal inbox 312, widget management engine 310, etc. The network gateway 318 may include a generic layer 320 that is in communication with database 322 residing in network gateway 318.

In an embodiment, generic layer 320 in network gateway 318 may extract information including business data from multiple business management systems 324, 326, 328, 330, 332 and 334. The generic layer 320 may communicate with the tables stored in database 322 in network gateway 318 and provide a common interface for accessing the business data from the databases in the multiple business management systems 324, 326, 328, 330, 332 and 334. Such an arrangement may optimize consumption of memory by applications that are executing in the multiple business management systems 324, 326, 328, 330, 332 and 334. The applications running on the multiple business management systems 324, 326, 328, 330, 332 and 334 may have access to tables and/or attributes and/or rows including the business data. The network gateway 318 may store local business rules and global business rules for validating the business data from the multiple business management systems 324, 326, 328, 330, 332 and 334. The local business rules may be executed to validate the business data from the multiple business management systems 324, 326, 328, 330, 332 and 334 and upon validation the business data may be stored in the database 322 in the network gateway 318.

In an embodiment, when the validation of the business data in network gateway 318 fails, the user may be notified by displaying an error message on the user interface and/or the dashboard. The global business rules may be executed to validate the business data, and upon validation the business data between multiple business management systems 324, 326, 328, 330, 332 and 334 may be synchronized. When the validation of business data based on global rules fails, the business data is not synchronized or replicated between multiple business management systems 324, 326, 328, 330, 332 and 334, but is stored locally in database 322 in the network gateway. The user may be notified by displaying suitable error message on the user interface or the dashboard.

In an embodiment, user management engine 316 may manage user registration, user identities, user authorization (e.g., using SSO) for accessing business data and/or the contextual information associated with the business data. The user management engine 316 may execute operations, such as user registrations, generate and validate user identities (e.g., user roles, profiles and access control to business data), provide user authorization or authentication, etc.

In an embodiment, framework middleware 304 may include routines to provide authorization to only certain sections (e.g., partially) of business data. For instance, using access control mechanisms, framework middleware 304 may be configured to provide an access to certain sections and/or content in a business document. Such a partial access to the content may be implemented by executing a combination of business rules and access control techniques. In an embodiment, the accessibility to the business data (e.g., text, multimedia, graphical visualizations, etc.) residing in the data fields in data structures (e.g., table, spreadsheet, etc.) may also be controlled. In an embodiment, the business document may be accessed by multiple business management systems over the network and additional business rules may be executed by framework middleware 304 to regulate operations, such as read only, write only, read-write, etc., depending on which business management system accesses the business document.

In an embodiment, framework middleware 304 may include routines that may validate the quality, consistency and integrity of business data retrieved from or replicated to the multiple business management systems 324, 326, 328, 330, 332 and 334. The framework middleware 304 may provide mechanisms for governing and maintain the integrity and consistency of the business data, when the business data is replicated to multiple business management systems 324, 326, 328, 330, 332 and 334. By way of example, consider that business data is stored in a business object. In an arrangement that includes multiple business management systems 324, 326,328, 330, 332 and 334, the business object may be accessed and modified by the multiple business management systems 324, 326, 328, 330, 332 and 334. The integrity and consistency of the business data in the business object may need to be validated before replicating it to the other business management systems. The integrity and consistency of the business data in the business object may be validated by executing business rules in framework middleware 304. The replication of the business object may be logged, tracked and stored in tables (e.g., tracking tables) in the database.

In an embodiment, business objects may encapsulate a function and the business data and may be linked with or dependent on other business objects. In such an arrangement, framework middleware 304 may execute routines for intelligent replication of the business objects (e.g., intelligent replication of business objects or business data includes executing routines in framework middleware 304 that work in conjunction with remote function calls (RFCs)). By way of example, consider a business object “OPPORTUNITY” is linked with business objects, such as “EMPLOYEE”, “BUSINESS PARTNER”, “PARTNER FUNCTION,” etc. When the business object “OPPORTUNITY” is to be distributed of shared (e.g., replicated) between multiple business management systems (e.g., 324, 326, 328, 330, 332 and 334), the execution of routines in the framework middleware 304 may determine that the business object “OPPORTUNITY” is linked with other business objects, such as “EMPLOYEE”, “BUSINESS PARTNER”, “PARTNER FUNCTION,” etc., and may replicate the other business objects (e.g., “EMPLOYEE”, “BUSINESS PARTNER”, “PARTNER FUNCTION,” etc.), when the business object “OPPORTUNITY” is replicated.

In an embodiment, framework middleware 304 may include routines to check for dependencies between the attributes of the same business object. For example, framework middleware 304 may include routines that determine dependency between ‘COUNTRY’ and ‘STATE’ data fields within the same business object. In another embodiment, the dependent data fields (e.g., ‘COUNTRY’ and ‘STATE’) may reside in different business objects. The execution of such routines in the framework middleware determines dependencies between the business objects and alerts the user when the situation of missing dependent business objects arises. In an embodiment, framework middleware 304 may be configured to replicate the business data to multiple business management systems (e.g., 324, 326, 328, 330, 332 and 334) on periodic basis. By way of example, such periodic time intervals may include immediately, hourly, daily, weekly, monthly, etc.

In an embodiment, when the business data or the business objects including the business data are modified (e.g., updated, deleted, added, etc.) in framework middleware 304, the modifications may be replicated to other business management systems. The framework middleware 304 may execute business rules to keep a track of such data modifications. The business data between the multiple business management systems (e.g., 324, 326, 328, 330, 332 and 334) may be replicated at periodic intervals of time (e.g., immediately, hourly, daily, weekly, etc.). Such periodic updates avoid situations that may generate inconsistent business data due to network latencies, business data packet loss, etc. The business data may be replicated between multiple business management systems (e.g., 324, 326, 328, 330, 332 and 334) based on the business requirements. In an embodiment, framework middleware 304 may include routines to determine duplication of the business data, when the business data is replicated. When duplicate business data is detected the end user may be notified of such duplication.

In an embodiment, framework middleware 304 may include routines that trigger specific events for specific values of the business data. The triggering of the events may be ordered and may be executed either in the same business management system or different business management systems (e.g., 324, 326, 328, 330, 332 and 334). The framework middleware 304 may provide functionalities, such as user group classification, user identification based on roles, responsibilities and attributes associated with the user identity, user authorization and authentication, etc. The framework middleware 304 may include routines to monitor user activities and generate alerts based on the user behavioral patterns.

In an embodiment, framework middleware 304 provides a holistic and integrated platform for the real-time analysis, aggregation and visualization of high volumes, velocities and diversity of the business data. The framework middleware 304 may include routines categorized as “sentiment intelligence” that may determine and analyze comments, suggestions and opinions posted by end users; deliver personalized engaging experiences that may be used to support and take more responsive business decisions. The framework middleware 304 may perform stream analysis that may monitor the incoming events in real time, detect error patterns, aggregate, analyze and respond to events, errors, etc., by triggering certain events, workflows, etc. The framework middleware 304 may execute routines to communicate with the multiple business management systems (e.g., 324, 326, 328, 330, 332 and 334) and track for updates in the business data. In an embodiment the multiple business management systems (324, 326, 328, 330, 332 and 334) may communicate with each other via the framework middleware 304. The multiple business management systems (e.g., 324, 326, 328, 330, 332 and 334) may be authenticated using digital and security certificates.

In an embodiment, framework middleware 304 may include routines to encrypt the business data retrieved from multiple business management systems (e.g., 324, 326, 328, 330, 332 and 334). The business data may be encrypted by executing data encryption algorithms. By way of example, consider that the business data may be encrypted by executing a sequential data encrypting algorithm. The sequential data encrypting algorithm may encrypt the business data using multiple keys (e.g., a first key, a second key, etc.). In an embodiment, the business data may be partitioned based on user preferences or using standard business data sizes (e,g., bits, bytes, words, etc,), and the sequential data encrypting algorithm may be executed to encrypt the partitioned business data.

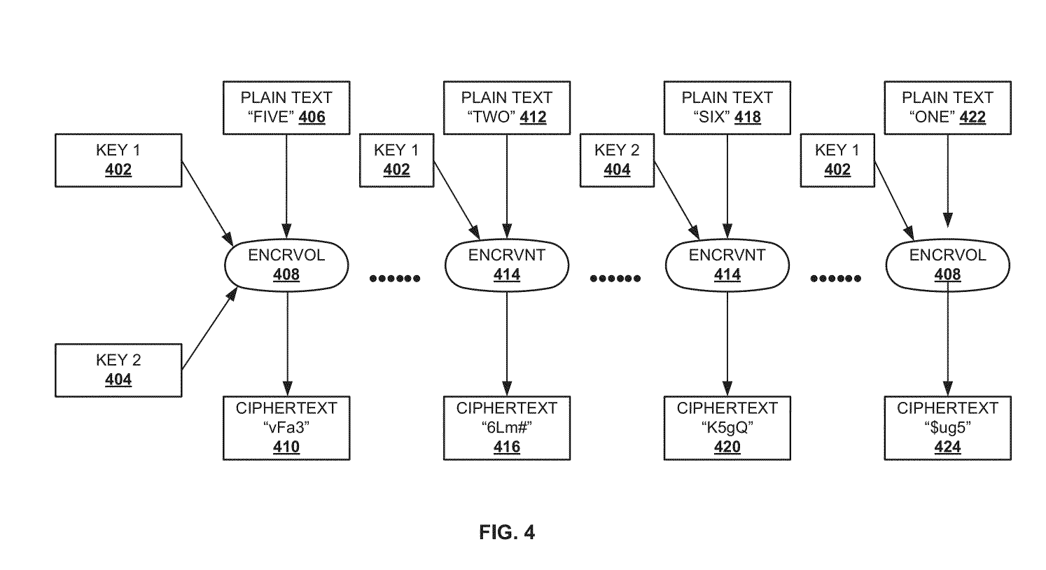

FIG. 4 is a block diagram illustrating a sequential data encrypting algorithm to encrypt business data, according to an embodiment. By way of illustration, FIG. 4 shows a mechanism to encrypt business data sequentially. In an embodiment, the execution of sequential data encryption algorithm to encrypt the business data may include: a first step of initialization that includes providing input of multiple keys (e.g., the first key 402 and the second key 404) and the first word 406 (e.g., business data) to be encrypted, and initialize a word count to ‘1’. The first word “FIVE” may be encrypted “ENCRVOL” 408 to get an encrypted word (e.g., CIPHERTEXT) “vFa3” 410. Upon encrypting the word in the first step, a second step may include encrypting a second word 412 (e.g., business data) using the output of the first step (e.g. word encrypted using the first key 402 and the second key 404). For instance, the second word “TWO” 412 may be encrypted (e.g., “ENCRVNT” 414) by using a combination of the output of the first step (“vFa3”) and the first key 402 to get an encrypted second word (e.g., CIPHERTEXT) “6Lm#” 416. Upon encrypting the second word 412, increment the word count by ‘1’. A third word “SIX” 418 may be encrypted (e.g., “ENCRVNT” 414) by using a combination of output of the second step (e.g., “6Lm#”) and the second key 404 and incrementing the word count by ‘1’. The encrypted third word may be represented by “K5gQ” 420.

In an embodiment, the business data may be encrypted by executing the above steps until the last word is reached. The encryption may continue until the word count reaches a desired number (e.g., word count =‘100’). When the value of word count reaches ‘100’, the words business logic for encrypting (e.g., “ENCRVOL” 408) the subsequent words (e.g., “ONE” 422) may include using a combination of the first key 402 and the encrypted word (e,g., “K5gQ” 420) from the previous iteration for encrypting the subsequent word to generated encrypted word “$ug5” 424 and so on.

In an embodiment, advantages of sequential encryption may include: an elimination of need for a random initialization vector for encrypting the business data, need for specific data sizes (e.g., bits, bytes, words, etc.) of business data, etc. Sequential encryption mechanism for encrypting the business data (e.g., as described above) provides robust data security and efficient data management and handling mechanisms, when the business data size varies. Based on the nature and property of business data, the user may be provided with an adaptability to customize or define the size of business data. Such adaptability may provide the user to partially encrypt blocks of business data.

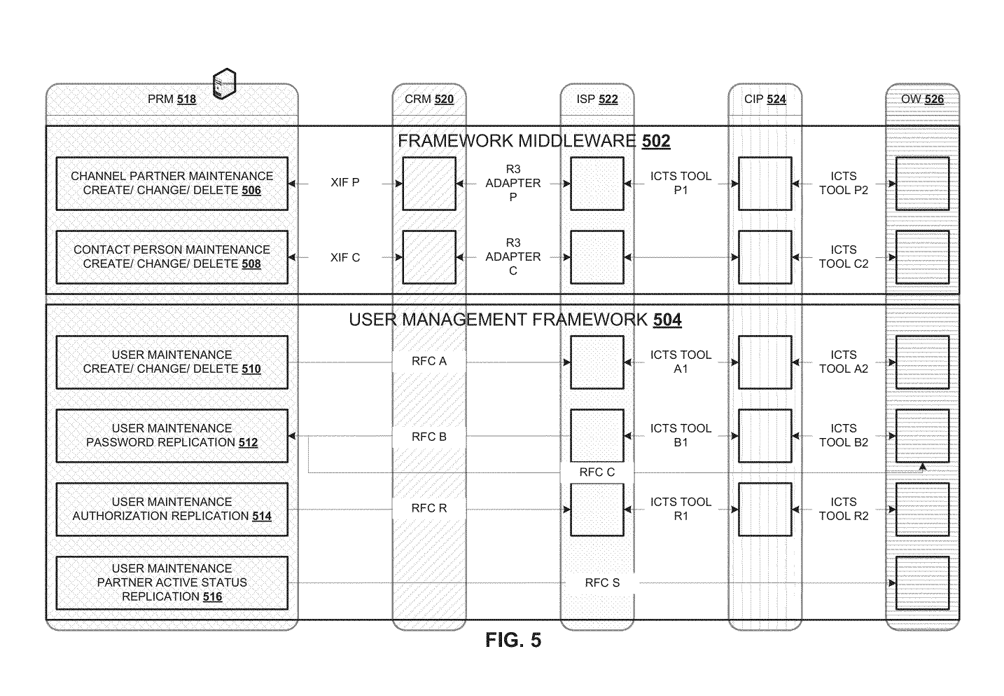

FIG. 5 is a block diagram illustrating an integration of user management framework and framework middleware, according to an embodiment. By way of illustration, FIG. 5 shows an integration of user management framework 504,and framework middleware 502 to manage user between multiple business management systems 5l8, 520, 522, 524 and 526. In an embodiment, a user may be registered via user management engine (e.g., 316 in FIG. 3) may be authenticated or authorized by executing routines in framework middleware 502. The routines may include instructions that may be packaged (e.g., software package of meta packages, classes, etc.) and stored in a hierarchy (e.g., packages may be bundled and may include instructions to execute operations related to UI components, database tables, message classes, shared memory classes, toolbox classes, data dictionary objects, online text repositories, authorization objects, reports, enterprise services, etc.). The packages may be stored in different layers in framework middleware 502 or in user management framework 504. In an embodiment, the software packages may be stored in groups (e.g., UI components may be bundled and stored in a Business Object Layer (BOL); Generic interaction Layer (GENIL) components may be stored as one package; proxy objects may be stored in one group; common and generic functions may be packaged and stored as one group; etc.).

By way of example, framework middleware 502 may include modules 506 and 508 to manage information related to channel partner and associated contacts (e.g., CHANNEL PARTNER MAINTENANCE 506 and CONTACT PERSON MAINTENANCE 508). The information related to channel partner and associated contacts may be modified (e.g., Create, Change, Delete, etc.) through user interface provided by the application. The information related to channel partner and associated contacts may be managed by executing routines in 506 and 508 in framework middleware 502. In an embodiment, user management framework 504 may include modules 510, 512, 514 and 516, The user management framework 504 may include creating and maintaining users (e.g., USER MAINTENANCE 510); user password replication (e.g., USER MAINTENANCE PASSWORD REPLICATION 512); user authorization replication (e.g., USER MAINTENANCE AUTHORIZATION REPLICATION 514); and partner status replication (e.g., USER MAINTENANCE PARTNER ACTIVE STATUS REPLICATION 516).

In an embodiment, when the user attempts to access business data via the user interface or the dashboard in the application, user management engine (e.g., 316 of FIG. 3) in framework middleware (e.g., 304 of FIG. 3) may be triggered to execute user authorization and authentication (e.g., user validation) routines. Such user validations may be executed in framework middleware (e.g., 304 of FIG. 3), while the application is being executed in a front end. As explained previously, such validations may be executed by matching the identifiers associated with the contextual information associated with the business data or the identifiers associated with the business data with the user attributes. Upon successful validation, the business data and/or the contextual information may be displayed on the user interface to the end user.

In an embodiment, the information associated with the users (510-516) may be replicated and managed across multiple business management systems (e.g., 518, 520, 522, 524 and 526). The users may be authenticated or authorized by using security certificates. The user may be assigned an identity and every request for accessing or modifying business data may be authenticated by an identity provide in framework middleware (e.g., 304 of FIG. 3). The identity provider may be configured to establish trusted communication between the user and multiple business management systems (e.g., 518, 520, 522, 524 and 526). The user authorization may also include attributes, such as user profiles, organizational roles, etc., that may be used to provide access to the business data.

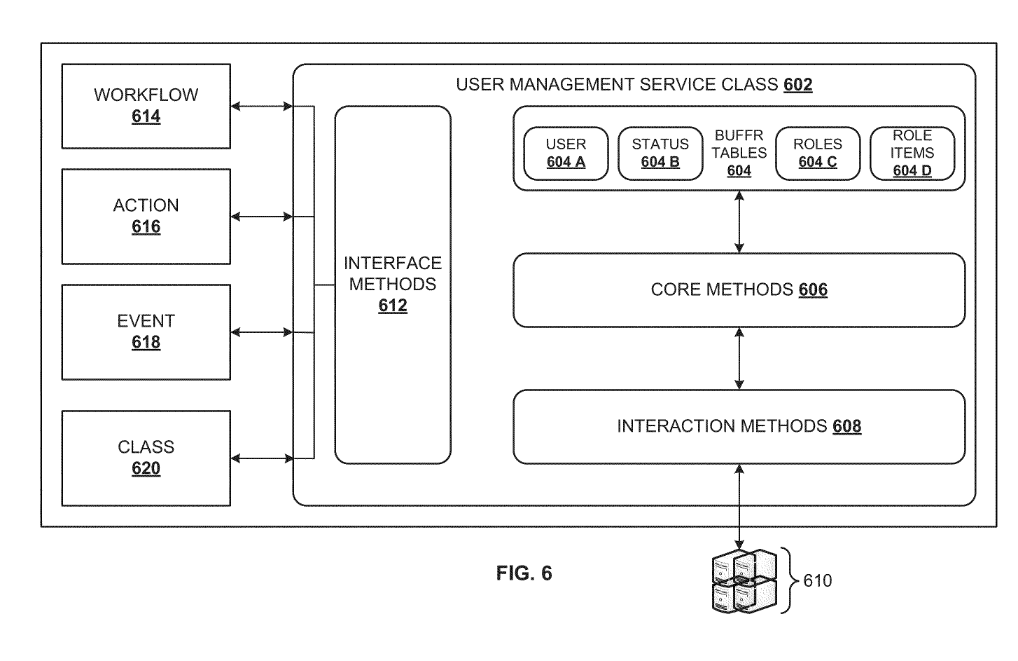

FIG. 6 is a block diagram illustrating a user management service class, according to an embodiment. By way of illustration, FIG. 6 shows user management service class 602 (e.g., user management framework (e.g., 504 of FIG. 5) implemented as a service class) that tray coordinate and manage all tasks and functionalities related to user management. In an embodiment, user management service class 602 may include buffer tables 604 (e.g., that store attributes and business data related to user 604 A, status 604 B, roles 604 C, role items 604 D, etc.), core methods 606, interaction methods 608, interface methods 612, etc., (e.g., all the above methods may be executed as routines in framework middleware (e.g., 304 of FIG. 3)). The interaction methods 608 may communicate with external business management systems 610 and core methods 606 may include business logic related to business data management. The interface methods 612 may be called or executed or invoked by internal workflow 614, action 616, event 618, or class 620 (e.g., other classes/methods). In an embodiment, user management service class 602 may also be used to create new users and assign user identities. The user management service class 602 may be configured to grant access to content at different levels such as at document level, version level, etc.

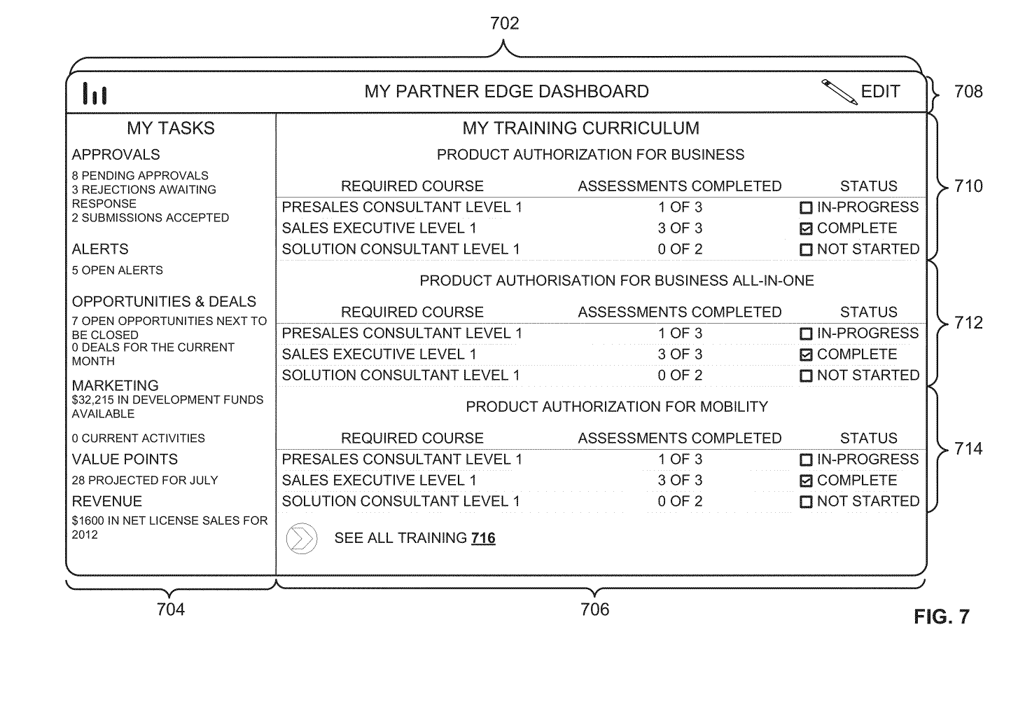

FIG. 7 is a block diagram showing a dashboard displaying contextual information associated with business data, according to an embodiment. In an embodiment, a data provisioning application may instantiate a user interface or dashboard 702 to display the contextual information associated with business data. By way of illustration, FIG. 7 shows dashboard 702 displaying contextual information (e.g., 710, 712 and 714; MY TRAINING CURRICULUM) associated with business data. The dashboard 702 includes status bar 708 rendering information related to a partner (e.g., MY PARTNER EDGE DASHBOARD). The information displayed on dashboard 702 may be modified or edited (e.g., by clicking on EDIT in 708). The dashboard 702 displays the contextual information (e.g., 710, 712 and 714) associated with the business data may include information that may be categorized (e.g., MY TASKS 704; MY TRAINING CURRICULUM 706).The contextual information (e.g., 710, 712 and 714) associated with the business data may be retrieved from multiple business management systems (e.g., 324, 326, 328, 330, 332 and 334 of FIG. 3) and displayed on dashboard 702. The training information associated with the other training may be accessed by clicking on 716.

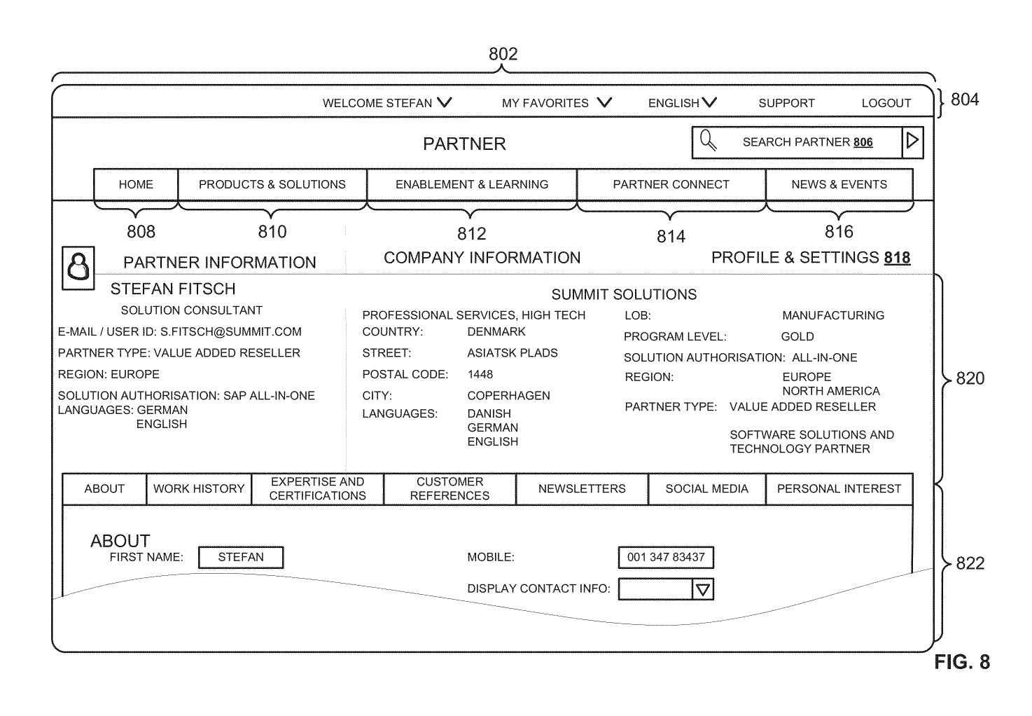

FIG. 8 is a block diagram illustrating a user interface displaying contextual information associated with business data, according to an embodiment. By way of illustration, FIG. 8 shows user interface 802 displaying contextual information (e.g., “PARTNER” information) associated with the business data. Status bar 804 on user interface 802 includes information associated with a user (e.g., WELCOME STEFAN), who is logged into the application; a UI element to navigate to favorite content (e.g., MY FAVORITES), a UI element to change language (e.g., ENGLISH); UI element to navigate to technical support (e.g., SUPPORT) and UI element to log off from the application (e,g., LOGOUT). The information associated with the partner may be searched by entering search query in 806. The partner information may be modified by clicking on “PROFILE & SETTINGS” 818. A user may click on the UI elements (e.g., TABS) 808, 810, 812, 814 and 816 and may navigate to the respective user interface to access the information therein. User interface 802, displays “PARTNER INFORMATION” and “COMPANY INFORMATION” as shown by 820. Other details related to the partner (e.g., STEFAN FITCH) may be accessed via the UI elements shown by 822.

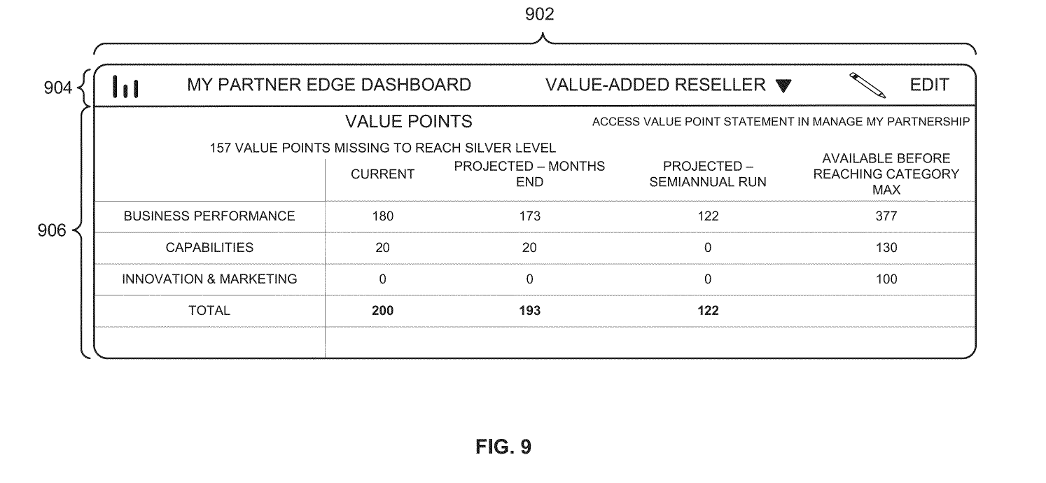

FIG. 9 is a block diagram illustrating a dashboard displaying contextual information associated with business data, according to an embodiment. By way of illustration, FIG. 9 shows dashboard 902 displaying contextual information 906 associated with the business data. Dashboard 902 shows status bar 904 that includes information related to partner (e.g., NW PARTNER EDGE DASHBOARD), status qualifier associated with the partner (e.g., VALUE-ADDED RESELLER) and UI element to modify or edit (e.g., EDIT) information associated with the partner. Dashboard 902 shows contextual information 906 that includes information associated with the “VALUE POINTS” and associated statistical business data.

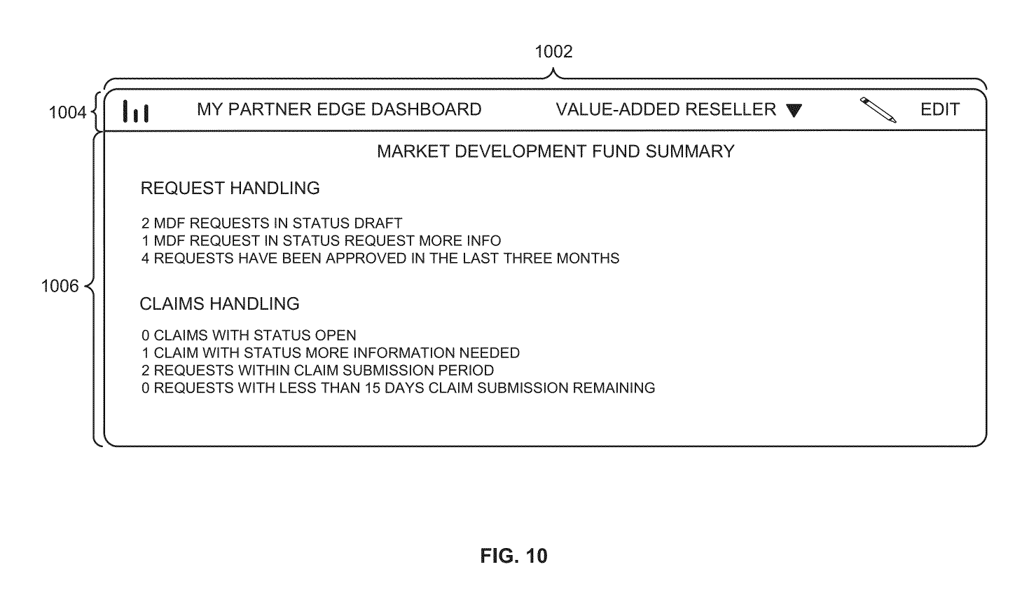

FIG. 10 is a block diagram illustrating a dashboard displaying contextual information associated with business data, according to an embodiment. By way of illustration, FIG. 10 shows dashboard 1002 displaying contextual information 1006 associated with the business data. Dashboard 1002 shows status bar 1004 that includes information related to partner (e.g., MY PARTNER EDGE DASHBOARD), status qualifier associated with the partner (e.g., VALUE-ADDED RESELLER) and UI element to modify or edit (e.g., EDIT) information associated with the partner. Dashboard 1002 shows contextual information 1006 that includes information associated with the “MARKET DEVELOPMENT FUND SUMMARY” including “REQUEST HANDLING” and “CLAIMS HANDLING” information.

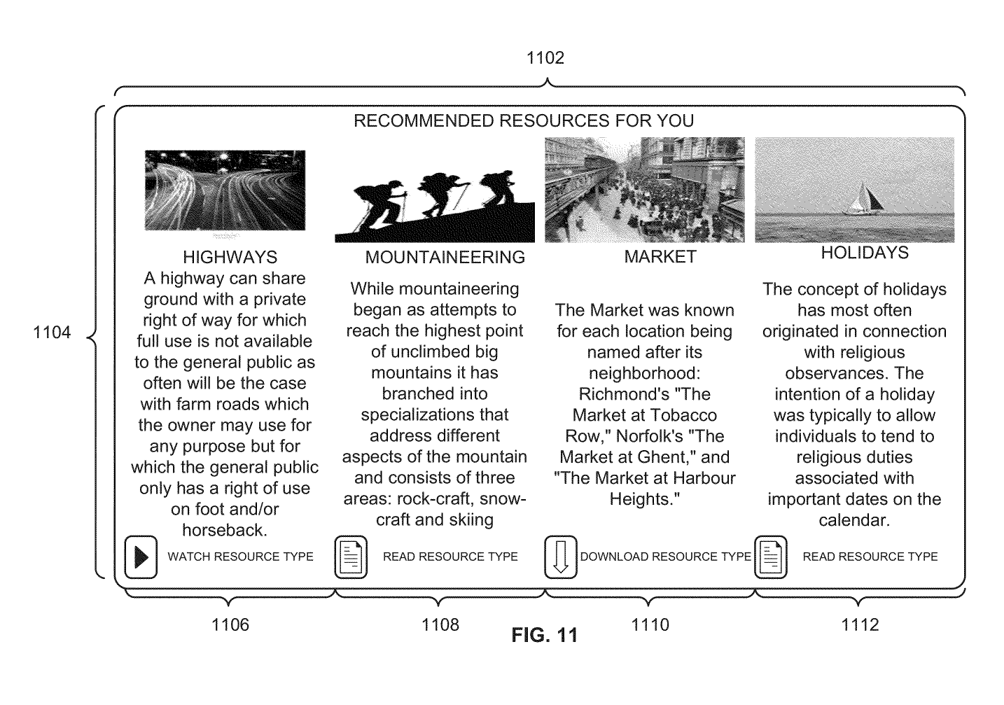

FIG. 11 is a block diagram illustrating a user interface displaying contextual information associated with business data, according to an embodiment. By way of illustration, FIG. 11 shows user interface 1102 displaying contextual information 1104 associated with the business data. The contextual information 1104 may be arranged in columns (e.g., 1106, 1108, 1110 and 1112) and displayed on user interface 1102. User interface 1102 shows contextual information 1104 (e.g., “RECOMMENDED RESOURCES FOR YOU”) including multimedia content (e.g., pictures, text, video, etc.). The contextual information arranged in columns (e.g., 1106, 1108, 1110 and 1112) may be customized based on user preferences (as explained previously).

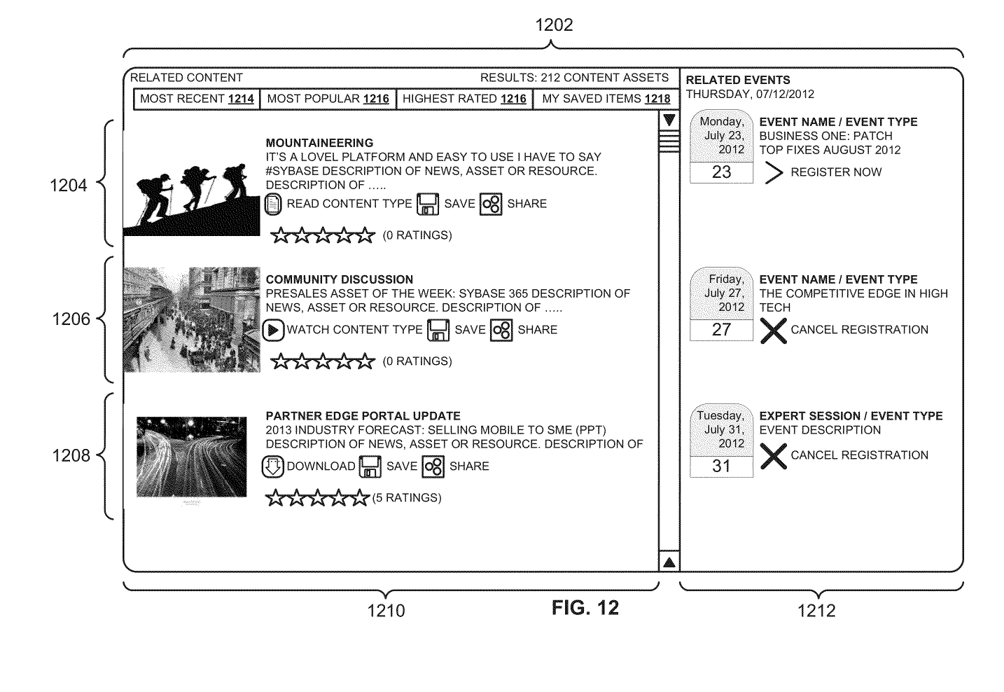

FIG. 12 is a block diagram illustrating a user interface displaying contextual information associated with business data, according to an embodiment. By way of illustration, FIG. 12 shows user interface 1202 displaying contextual information (e.g., 1204, 1206 and 1208) associated with the business data. User interface 1202 shows contextual information 1210 and related events 1212. The contextual information including the related events 1212 may provide a facility to register and/or cancel registration for the event. A user has an option to read content (e.g., 1204), watch content (e.g., 1206, when content is multimedia type) or download content (e.g., 1208), etc. The contextual information (e.g., 1204, 1206 and 1208) may be saved or shared by clicking on the respective icon (e.g., SAVE, SHARE in 1204, 1206 and 1208),

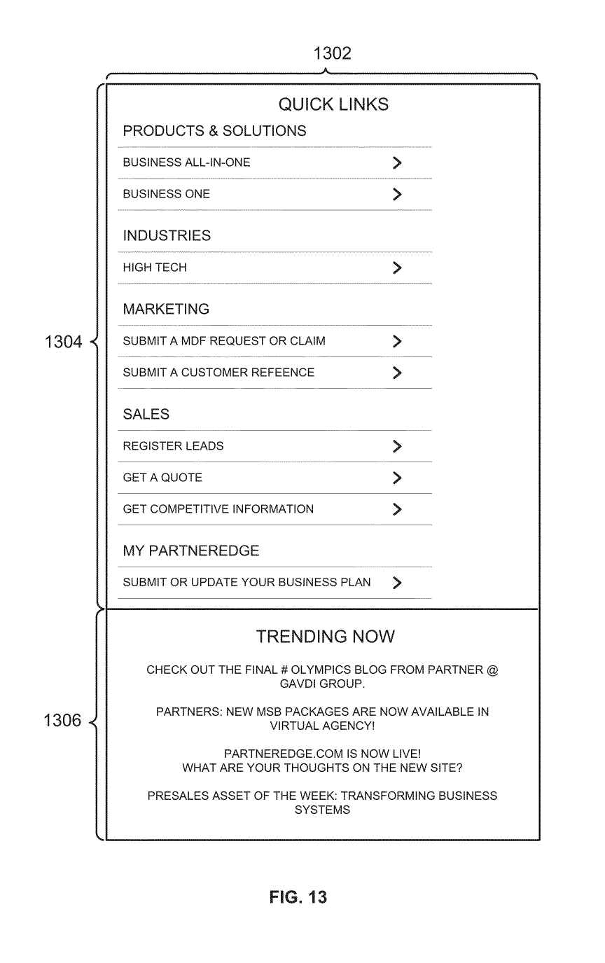

FIG. 13 is a block diagram illustrating a user interface displaying contextual information associated with business data, according to an embodiment. By way of illustration, FIG. 13 shows user interface 1302 contextual information (e.g., 1304 and 1306) associated with business data. The contextual information 1304 shows “QUICK LINKS” that may be used to navigate to the respective content (e.g., dashboards or user interfaces displaying the respective content). The contextual information 1306 includes “TRENDING NOW” that may display the latest and or popular updates related to events, launch of products, etc.

Some embodiments may include the above-described methods being written as one or more software components. These components, and the functionality associated with each, may be used by client, server, distributed, or peer computer systems. These components may be written in a computer language corresponding to one or more programming languages such as functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a tangible computer readable storage medium. A computer readable storage medium may be a non-transitory computer readable storage medium. Examples of anon-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++ or other object-oriented programming language and development tools. Another embodiment may be implemented in hard-wired circuitry in place of, or in combination with machine readable software instructions.

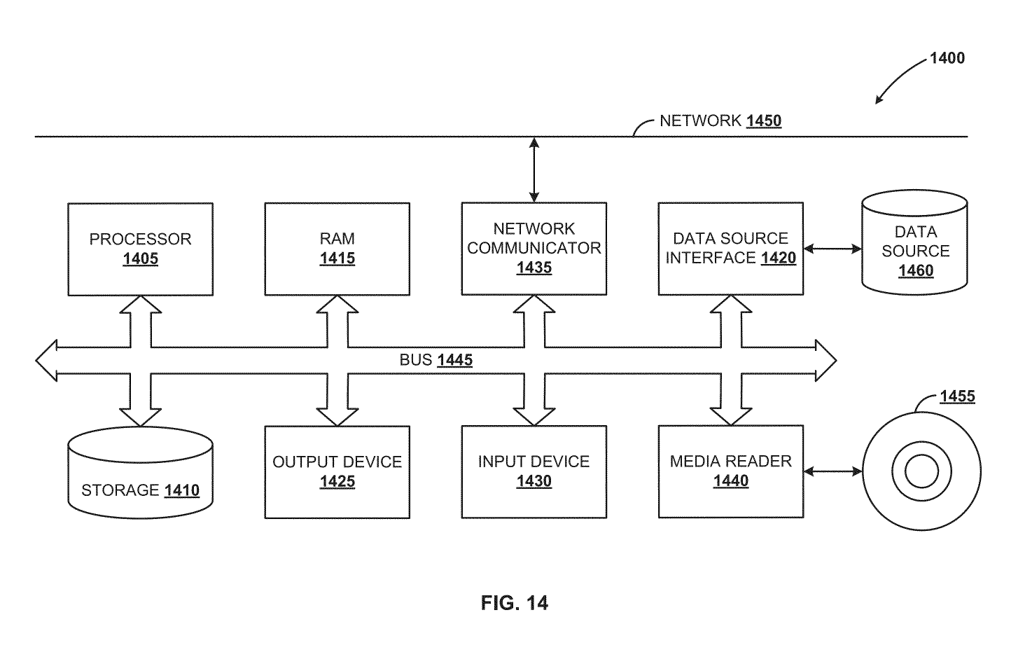

FIG. 14 is a block diagram of an exemplary computer system 1400, according to an embodiment. Computer system 1400 includes processor 1405 that executes software instructions or code stored on computer readable storage medium 1455 to perform the above-illustrated methods. Processor 1405 can include a plurality of cores. Computer system 1400 includes media reader 1440 to read the instructions from computer readable storage medium 1455 and store the instructions in storage 1410 or in random access memory (RAM) 1415. Storage 1410 provides a large space for keeping static data where at least some instructions could be stored for later execution. According to some embodiments, such as sonic in-memory computing system embodiments, RAM 1415 can have sufficient storage capacity to store much of the data required for processing in RAM 1415 instead of in storage 1410. In some embodiments, all of the data required for processing may be stored in RAM 1415. The stored instructions may be further compiled to generate other representations of the instructions and dynamically stored in RAM 1415. Processor 1405 reads instructions from RAM 1415 and performs actions as instructed. According to one embodiment, computer system 1400 further includes output device 1425 (e.g., a display) to provide at least some of the results of the execution as output including, but not limited to, visual information to users and input device 1430 to provide a user or another device with means for entering data and/or otherwise interact with computer system 1400. Each of these output devices 1425 and input devices 1430 could be joined by one or more additional peripherals to further expand the capabilities of computer system 1400. Network communicator 1435 may be provided to connect computer system 1400 to network 1450 and in turn to other devices connected to network 1450 including other clients, servers, data stores, and interfaces, for instance. The modules of computer system 1400 are interconnected via bus 1445. Computer system 1400 includes a data source interface 1420 to access data source 1460. Data source 1460 can be accessed via one or more abstraction layers implemented in hardware or software. For example, data source 1460 may be accessed by network 1450. In some embodiments data source 1460 may be accessed via an abstraction layer, such as a semantic layer.

A data source is an information resource. Data sources include sources of data that enable data storage and retrieval. Data sources may include databases, such as relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, sonic concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A system to improve user experience when consuming business data, comprising:
a processor, and
one or more memory devices communicatively coupled with the processor and storing instructions related to:
receiving a request, at a framework middleware via an application, to establish a connection with a plurality of business management systems;
upon establishing the connection, the framework middleware retrieving business data from the plurality of business management systems;
based on an execution of a plurality of routines in the framework middleware, triggering a system landscape transformation model to transform the retrieved business data;
determining a contextual information associated with the transformed business data; and
rendering the determined contextual information on a user interface of the application, wherein the contextual information is customizable based on one or more parameters.

2. The system of claim 1, further comprising: replicating the business data from the plurality of business management systems and storing the replicated business data in the application.

3. The system of claim 1, wherein the framework middleware further comprises: a network gateway including a generic layer and a database in communication with the plurality of business management systems.

4. The system of claim 3, wherein: upon successful validation of the business data in the database using a global business rule, replicate the business data from the database in the network layer to the plurality of business management systems.

5. The system of claim 1, wherein the framework middleware executes a plurality of routines related to web content management service, document management service, dashboard management service, widget management service and workflow management service.

6. The system of claim 1, wherein the framework middleware executes the plurality of routines to validate the business data from the plurality of business management systems, using one or more local business rules.

7. The system of claim 1, wherein the framework middleware executes the plurality of routines to encrypt the business data by a sequential data encryption algorithm.

8. A computer implemented method to improve user experience when consuming business data, comprising:
receiving a request, at a framework middleware via an application, to establish a connection with a plurality of business management systems;
upon establishing the connection, the framework middleware retrieving business data from the plurality of business management systems;
based on an execution of a plurality of routines in the framework middleware, triggering a system landscape transformation model to transform the retrieved business data;
determining a contextual information associated with the transformed business data; and
rendering the determined contextual information on a user interface of the application, wherein the contextual information is customizable based on one or more parameters.

9. The computer implemented method of claim 8, further comprising: replicating the business data from the plurality of business management systems and storing the replicated business data in the application.

10. The computer implemented method of claim 8, wherein the framework middleware further comprises: a network gateway including a generic layer and a database in communication with the plurality of systems.

11. The computer implemented method of claim 8, wherein: upon successful validation of the business data in the database using a global business rule, replicate the business data from the database in the network layer to the plurality of business management systems.

12. The computer implemented method of claim 8, wherein the framework middleware executes the plurality of routines related to web content management service, document management service, dashboard management service, widget management service and workflow management service.

13. The computer implemented method of claim 8, wherein the framework middleware executes the plurality of routines to validate the business data from the plurality of business management systems, using one or more local business rules.

14. The computer implemented method of claim 8, wherein the framework middleware executes the plurality of routines to encrypt the business data by a sequential data encryption algorithm.

15. A non-transitory computer readable storage medium tangibly storing instructions, which when executed by a computer, cause the computer to execute operations comprising:
receiving a request, at a framework middleware via an application, to establish a connection with a plurality of business management systems;
upon establishing the connection, the framework middleware retrieving business data from the plurality of business management systems;
based on an execution of a plurality of routines in the framework middleware, triggering a system landscape transformation model to transform the retrieved business data;
determining a contextual information associated with the transformed business data; and
rendering the determined contextual information on a user interface of the application, wherein the contextual information is customizable based on one or more parameters.

16. The non-transitory computer readable storage medium of claim 15, further comprising instructions that cause the computer to execute operations comprising:
replicating the business data from the plurality of business management systems and storing the replicated business data in the application.

17. The non-transitory computer readable storage medium of claim 15, further comprising instructions that cause the computer to execute operations comprising: a network gateway that includes a generic layer and a database in communication with the plurality of business management systems.

18. The non-transitory computer readable storage medium of claim 17, wherein: upon successful validation of the business data in the database using a global business rule, replicate the business data from the database in the network layer to the plurality of business management systems.

19. The non-transitory computer readable storage medium of claim 15, wherein the framework middleware executes the plurality of routines related to web content management service, document management service, dashboard management service, widget management service and workflow management service.

20. The non-transitory computer readable storage medium of claim 15, wherein the framework middleware executes the plurality of routines to validate the business data from the plurality of business management systems, using one or more local business rules.
